(19) United States
(12) Patent Application Publication
(10) Pub. No.: US 2003/0101044 A1
(43) Pub. Date: May 29, 2003

(54) Word, expression, and sentence translation management tool

(76) Inventor: Mark Krasnov, Houston, TX (US)

Correspondence Address: ROSENTHAL & OSHA, 1221 McKinney, Suite 2800, Houston, TX, 77010, US

(21) Appl. No.: 10/309,617

(22) Filed: Dec. 3, 2002

Related U.S. Application Data
(63) Continuation-in-part of application No. 10/141,404, filed on May 8, 2002.
(60) Provisional application No. 60/333,927, filed on Nov. 28, 2001.

(51) Int. Cl. G06F 17/28

(52) U.S. Cl. 704/4

(57) ABSTRACT

A translation management tool and method includes comparing a selected text string to a segment in a domain, indicating matches between the selected text string and at least a portion of the segment, displaying the selected text string and a matching segment paired with a translation of the matching segment, and selectively allowing replacement of the selected text string with at least a portion of the translation of the matching segment. A translation management tool and method includes displaying a segment in a first language, displaying a translation of the segment in a second language, indicating a term from the segment, indicating a translation of the term from the translation of the segment, and adding the term and the translation of the term as a paired bilingual set to a specified glossary.

### CROSS-REFERENCE TO RELATED APPLICATIONS

This application claims priority to Provisional Patent Application No. 60/333,927 filed Nov. 28, 2001 and claims the benefit as a Continuation-in-Part of U.S. patent application Ser. No. 10/141,404 filed May 8, 2002, entitled “Word, Expression, and Sentence Translation Management Tool,” in the name of Mark Krasnov. Both the Provisional Application 60/333,927 and the U.S. patent application Ser. No. 10/141,404 are hereby incorporated by reference.

### BACKGROUND OF INVENTION

In the art of computerized foreign language translation currently there exist machine translation tools and memory translation tools. Using machine translation tools, a block of text or sentence is translated via word by word look-up of each sentence of text. Thus, each translated word is directly looked up in a dictionary database. The machine translation software then combines these translations into a meaningful sentence. Using translation memory tools, a block of text is translated directly sentence by sentence or segment by segment. That is, each sentence or segment is looked-up in a previously compiled database of linguistic phrases and sentences. This method is an improvement over machine translation based on the amount of these phrases found in the linguistic phrase database.

Various methods have been employed to allow the translation of documents via purely computerized means. For example, Carbonell et al., in U.S. Pat. No. 6,173,785, disclose an interactive text editor that enforces lexical and grammatical constraints on a natural language subset used by authors to create original text. These constraints help disambiguate the text to ensure translatability. Further, Motoyama, in U.S. Pat. No. 6,208,956, teaches encoding documents with Standard Generalized Markup Language (SGML) tags and using different translation resources depending on the tags. The tags may indicate types of documents or portions of the document being translated. By encoding the document this way, more accurate machine translation can be performed without imposing overly restrictive rules on the words and phrases included in the document to be translated.

Other methods of constraining and structuring grammar and vocabulary are also known. Different manners of handling semantic and idiomatic words and phrases, and methods of handling words with multiple meanings using statistical analysis are being developed and improved. Further, modem translation systems may include side-by-side views of original text and translated text to assist users. Additionally, these systems may allow users to select portions of the machine translation to be accepted and other portions to be rejected.

### SUMMARY OF INVENTION

According to one aspect, a translation management method comprises comparing a selected text string to a segment in a first domain; indicating a match between the selected text string and at least a portion of the segment; displaying the selected text string and a matching segment paired with a translation of the matching segment; and selectively allowing replacement of the selected text string with at least a portion of the translation of the matching segment.

According to one aspect, a translation management tool comprises a first domain containing a segment and a translation of the segment; and software executable on a computer for comparing a selected text string to the segment; indicating a match between the selected text string and at least a portion of the segment; displaying the selected text string and a matching segment paired with a translation of the matching segment; and selectively allowing replacement of the selected text string with at least a portion of the translation of the matching segment.

According to one aspect, a translation management tool comprises at least one domain containing a segment paired with translation of the segment; means for comparing a selected text string to the segment in the at least one domain; means for indicating matches between the selected text string and at least a portion of the segment; means for displaying the selected text string and a matching segment paired with a translation of the matching segment; and means for selectively allowing replacement of the selected text string with at least a portion of the translation of the matching segment.

According to one aspect, a translation management method comprises displaying a segment in a first language; displaying a translation of the segment in a second language; indicating a term from the segment; indicating a translation of the term from the translation of the segment; and adding the term and the translation of the term as a paired bilingual set to a specified glossary.

According to one aspect, a translation management tool comprises a first glossary containing a first term and a translation of the first term; a second glossary containing a second term and a translation of the second term; and software executable on a computer for displaying a segment in a first language; displaying a translation of the segment in a second language; indicating a term from the segment; indicating a translation of the term from the translation of the segment; and adding the term and the translation of the term as a paired bilingual set to at least one of the group consisting of the first glossary and the second glossary.

Other aspects and advantages of the invention will be apparent from the following description and the appended claims.

### BRIEF DESCRIPTION OF DRAWINGS

FIG. 1 shows a typical computer system on which one or more embodiments of the present invention may be implemented.

FIG. 2 shows an exemplary GUI visual output in accordance with one or more embodiments of the present invention.

FIG. 3 shows an enlarged view of a portion of the exemplary GUI visual output shown in FIG. 2.

FIG. 4 shows a lookup window in accordance with one or more embodiments of the present invention.

FIG. 5 shows an exemplary options window in accordance with one or more embodiments of the present invention.

FIG. 6 shows an active glossary set window in accordance with one or more embodiments of the present invention.

FIG. 7 is a flow diagram describing a process in accordance with one or more embodiments of the present invention.

FIG. 8 is a flow diagram describing an exemplary second match processing method in accordance with one or more embodiments of the present invention.

FIG. 9 shows an exemplary resulting document after comparison in accordance with one or more embodiments of the present invention.

FIG. 10 shows an exemplary translation window in accordance with one or more embodiments of the present invention.

FIG. 11 shows an exemplary GUI visual output in accordance with one or more embodiments of the present invention.

FIG. 12 shows an exemplary glossary builder options window in accordance with one or more embodiments of the present invention.

FIG. 13 shows an exemplary glossary builder window in accordance with one or more embodiments of the present invention.

FIG. 14 shows an exemplary domain search result window in accordance with one or more embodiments of the present invention.

FIG. 15 shows an exemplary document after replacement in accordance with one or more embodiments of the present invention.

FIG. 16 is a flow diagram describing a process in accordance with one or more embodiments of the present invention.

FIG. 17 is a flow diagram describing a process in accordance with one or more embodiments of the present invention.

### DETAILED DESCRIPTION

Specific embodiments of the invention will now be described in detail with reference to the accompanying figures. Like elements in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, wellknown features have not been described in detail to avoid obscuring the invention.

The present invention relates to a method and apparatus for foreign language translation involving Universe translation tools. Universe translation tools relate to a translation assistance device. The Universe translation tools analyze sentences and provide additional definitional information based on words and phrases found. Based on the words and phrases found in a given sentence, those words and phrases are looked-up in a specific glossary to provide the additional definitional information. The glossaries contain source and target language definitional phrases and are specific to given identifiable topics. Glossaries are project and/or subject specific documents and are more narrowly tailored to one or more translations of a given word or phrase than a dictionary. Dictionaries are typically broad documents covering all possible definitions and respective translations for a word or phrase. Further, the Universe translation tools apply to any language pair, e.g., English to/from French, English to/from Spanish, English to/from Russian, etc.

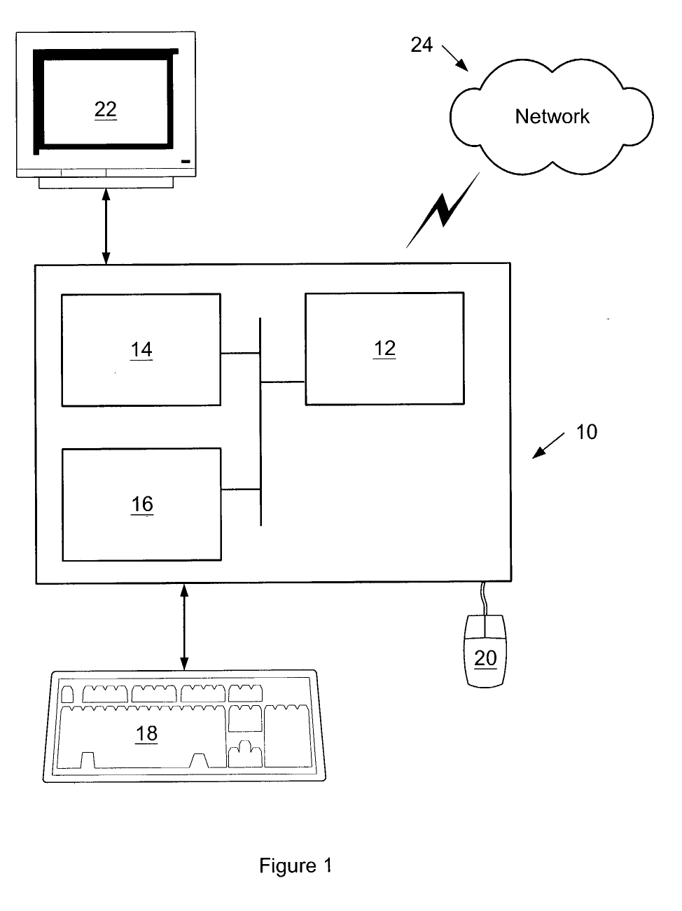

The invention may be implemented on virtually any type computer regardless of the platform being used. For example, as shown in FIG. 1, a typical computer (10) has a processor (12), associated memory (14), a storage device (16), and numerous other elements and functionalities typical to today's computers (not shown). The computer (10) has associated therewith input means such as a keyboard (18) and a mouse (20), although in an accessible environment these input means may take other forms. The computer (10) is also associated with an output device such as a display (22), which may also take a different form in an accessible environment. The computer (10) may be connected to a network or other resources (24).

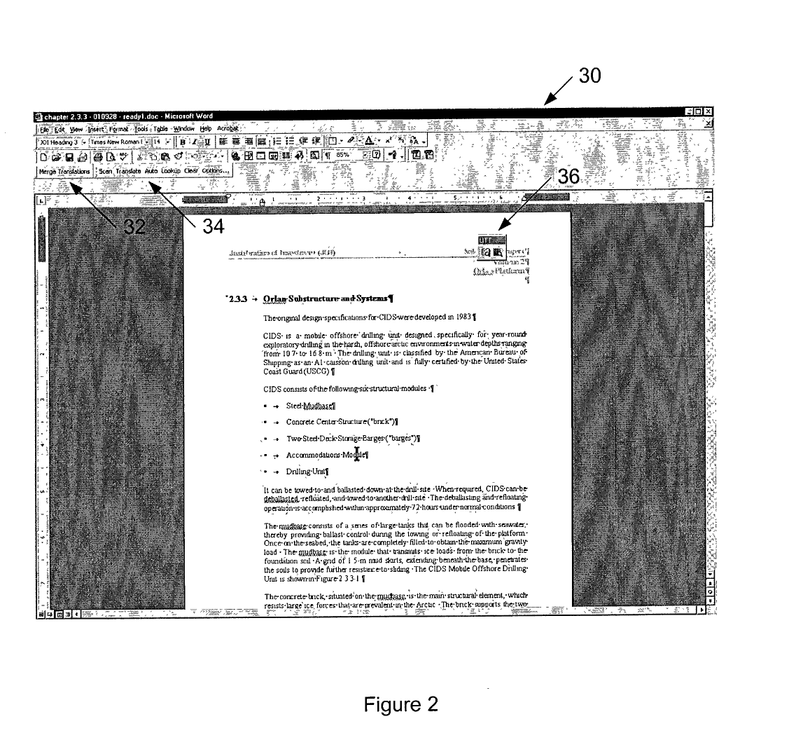

Referring to FIG. 2, the Universe translation tools are resident and selectable widgets existing in a Graphical User Interface (GUI), for example, buttons on the tool bar of Microsoft Word®. A GUI is part of a software application that interacts with a user via a graphical display. The GUI receives input from the user through different modes of access, such as a mouse and pointer combination, or through a keyboard. A visual output of a GUI is typically displayed on a display device, such as a computer monitor screen, and includes widgets that allow the user to interact with the GUI. Examples of widgets include windows, captions, buttons, labels, menu bars, toolbars, dialog boxes, menus, icons, etc. Widgets may also represent software applications that may be executed by the user or a pointer icon that represents the position of the mouse.

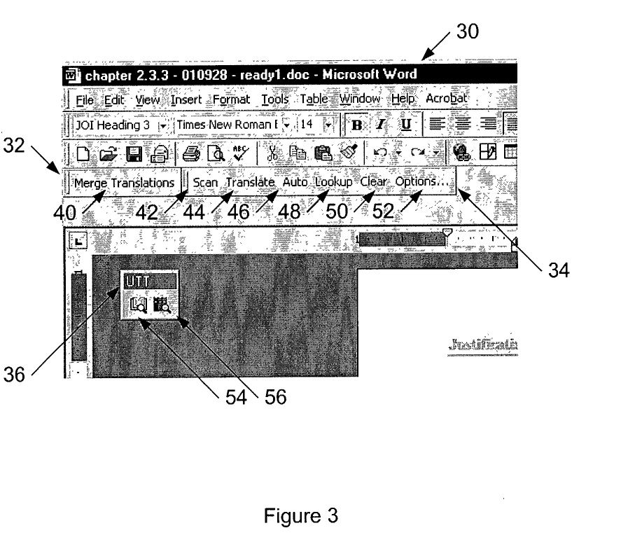

An exemplary GUI visual output is shown in FIGS. 2-3. As can be seen, a window (30) displays Microsoft Word(®) together with an open document. The Universe translation tool buttons are included in fixed tool bars, e.g., tool bars (32), (34) and floating tool bars, e.g., tool bar (36). These tool bars (32), (34), (36), represent various functions of the Universe translation tool software. Those skilled in the art will appreciate how to create and allow dynamically positioning of widgets such as these. Accordingly, detailed description of such processes is not included herein.

The various buttons of the tool bars (32), (34), (36) invoke different functions of the Universe translation tool software. Specifically, the fixed tool bar (32) contains a “Merge Translation” button (40), which causes the translations of known terms into the text of the document.

In the fixed tool bar (34), 6 buttons, i.e., a “scan” button (42), a “translate” button (44), an “auto” button (46), a “lookup” button (48), a “clear” button (50), and an “options . . . ” button (52). These buttons cause various functions to be invoked. The scan button (42) causes the active document to be scanned for known terms and the found terms to be identified. The translate button (44) causes the known terms in the active document to be translated. This translation process proceeds similarly to spell checking. Known terms are shown together with their translation and a user may choose to insert the translation or insert all translations. The auto button (46) searches the document for known terms and automatically inserts translations for all known terms found. The lookup button (48) causes a highlighted term to be searched for in the active glossaries or, if no text is highlighted, causes a lookup window to be displayed. The clear button (50) removes all notations regarding known terms from the active document. The options . . . button (52) causes the glossary options window to be displayed.

In the floating tool bar (36), icons representing the lookup command, i.e., icon button (54), and the view active glossary set command, i.e., icon button (56) are included. The icon button (54) causes a highlighted term to be searched for in the active glossaries or, if no text is highlighted, causes a lookup window to be displayed. This allows users to search for known terms in a specified glossary. The button (56) causes the active set of glossaries to be displayed. From this window, user can change which glossaries are active and the priority of the active glossaries. Those skilled in the art will appreciate that the labels and icons used as well as the positioning and organization of the buttons described above are merely exemplary and may be modified in numerous ways without departing from the scope of the invention.

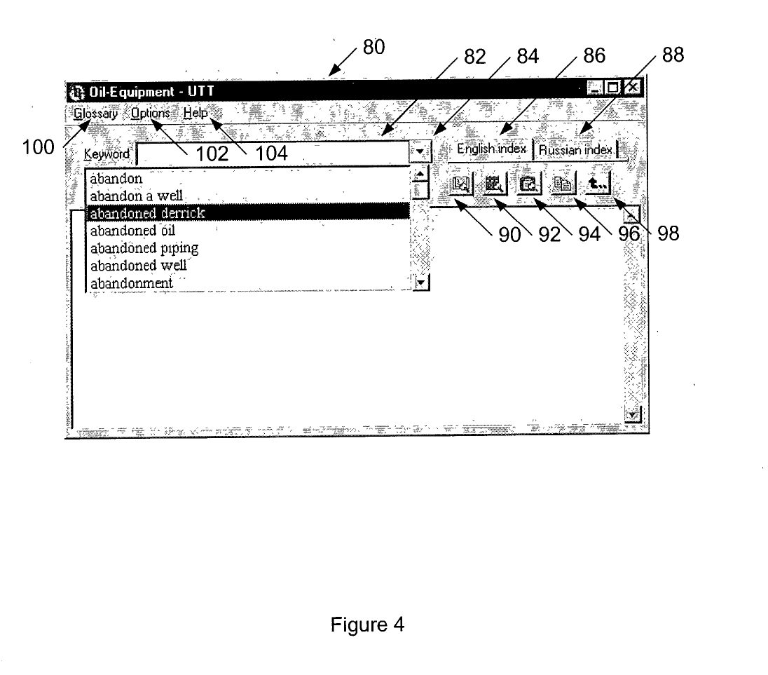

FIG. 4 shows a lookup window in accordance with one or more embodiments of the present invention. The lookup window (80) is displayed when the lookup button (48) or icon button (54) is selected. The lookup windows (80) includes a text box (82) for the entry of a keyword to be looked up together with a pull down menu (84) of terms found in the glossary. Users can select between language indexes with tabs (86), (88). In the example, shown English index and Russian index tabs are included.

Control buttons (90), (92), (94), (96), (98) allow a selected term to be looked up, the active glossary set to be viewed and modified, the clipboard to be viewed and modified, a copy function to be performed, and a back function to be performed respectively. Menu items are also included in the lookup window, which allow various functions to be performed. The “glossary” menu item (100) causes the active glossary set window to be displayed. From the active glossary set window, a user can select a glossary and add, remove, and prioritize glossaries in the active set. The “options” menu item (102) causes the glossary options window to be displayed. From the glossary options window, a user may modify how the Universe translation tools search documents, the source language of the document to be searched, and how found terms are identified in the document. Lastly, the “help” menu item (104) causes a help window to be displayed. The help window contains program documentation.

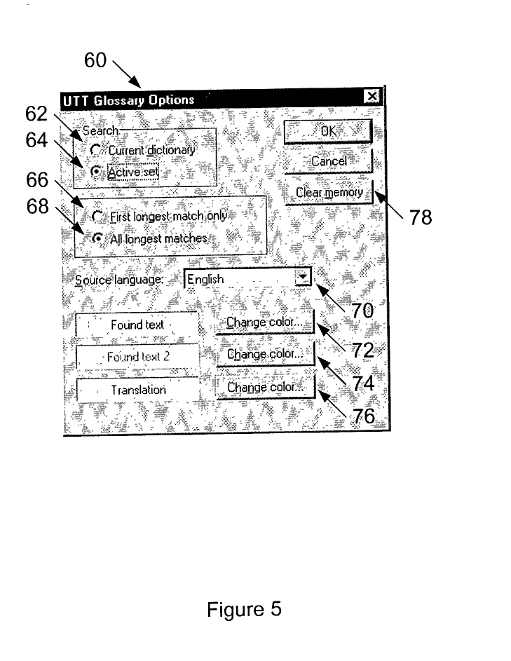

Referring to FIG. 5, the glossary options window (60) is shown. The glossary options window (60) is displayed when the options button (52) is selected. From the glossary options window (60), a user may modify how the Universe translation tools search documents, the source language of the document to be searched, and how found terms are identified in the document.

As an example, radio buttons (62), (64) are used to allow a user to select between searching for terms only in the current glossary or in the active set respectively. Radio buttons (66), (68) are used to allow a user to select between identifying only the first longest match or all longest matches respectively. A pull down menu (70) is used to allow the source language of the document to be selected. Finally, change color buttons (72), (74), (76) allow a user to select which colors indicate found terms and identify translation text respectively. Also, clear memory button (78) removes all notations regarding known terms and translations from the active document like clear button (50). Lastly, ok and cancel buttons are included and operate similarly to other standard windows.

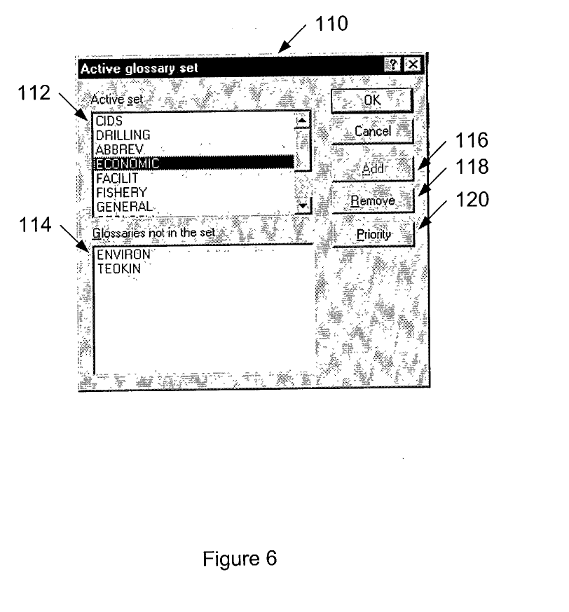

FIG. 6 shows an active glossary set window in accordance with one or more embodiments of the present invention. The active glossary set (110) is displayed when the icon button (56) or the glossary menu item (100) in the lookup window (80) is selected. From the active glossary set window, a user can select a glossary and add, remove, and prioritize glossaries in the active set. All available glossaries are listed in either, the active set box (112) or the glossaries not in the active set box (114). Glossaries can be added or removed from the active set using buttons (116) and (118) respectively after selecting the glossary from the appropriate box.

A “top-down” priority is associated with the glossaries listed in the active set. To change the priority of a glossary, the priority button (120) is used after selecting the glossary. In the example shown, a single priority button is included and acts as a “bubble-up” in priority, i.e., the selected glossary moves up to the next higher priority each time the priority button is pressed. Those skilled in the art will appreciate many variations of this function are available that do not depart from the scope of the invention. Lastly, ok and cancel buttons are included and operate similarly to other standard windows.

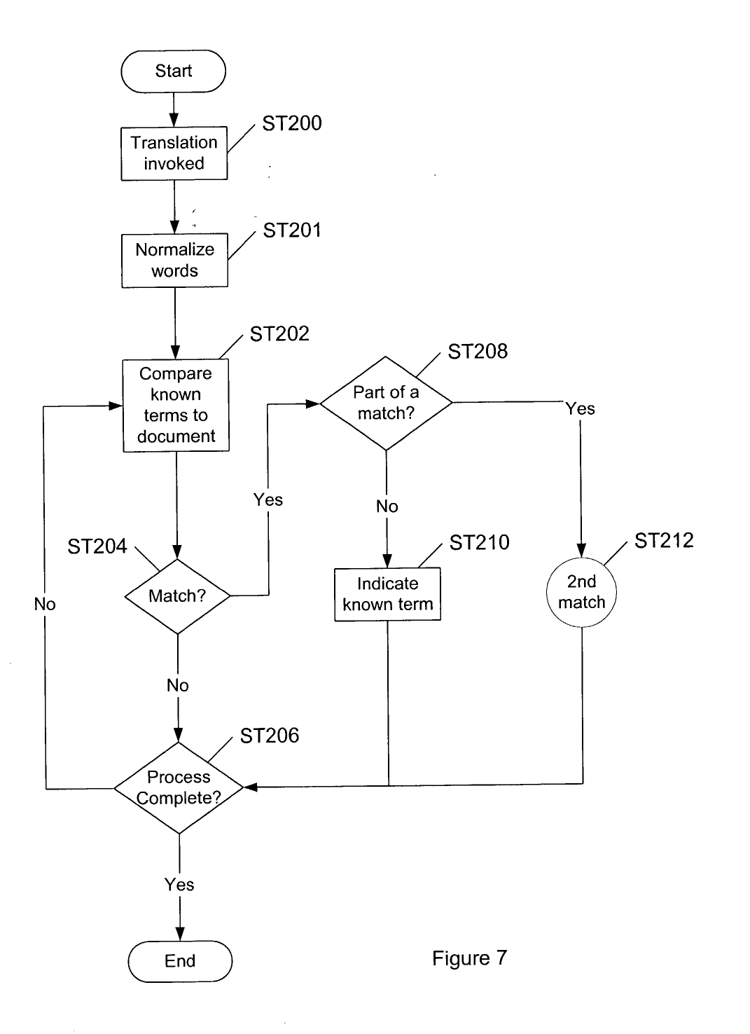

FIG. 7 is a flow diagram describing a process in accordance with one or more embodiments of the present invention. When a user selects one of the translation invoking buttons described above (step 200), the open document is parsed for known terms (step 202). Prior to parsing, the selected terms are normalized (step 201). Normalization is a process which is used to bring words to their root component for comparison to those words appearing in a given glossary. For the English language, normalization involves finding plural nouns and past tense verbs and converting them to singular and present tense respectively. Those skilled in the art will appreciate that in other languages normalization may involve a more complex determination of the root component of a particular word.

The parsing of the document may involve comparing the terms included in the active glossary or active set of glossaries to the text of the document to find matches. As the comparison progresses, when there is no match for a known term in the text of the document (step 204), the system determines whether all known terms have been compared and the process is now complete (step 206). If so, the process ends. Otherwise, the system continues comparing known terms to the text of the document (step 202).

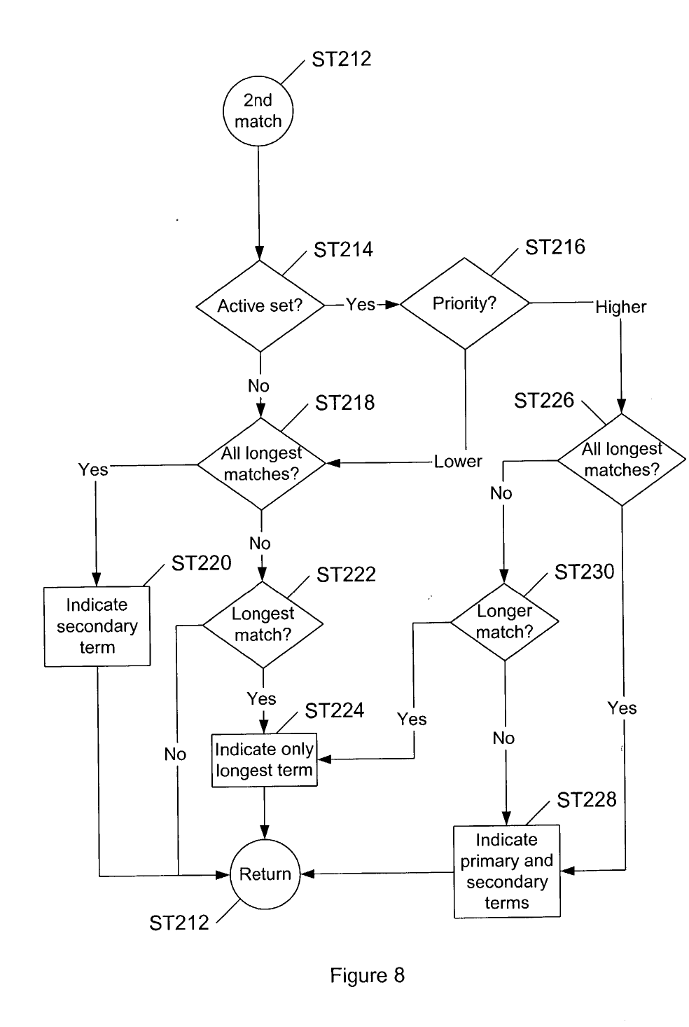

When a match for a known term is found (step 204), the system determines whether the known term found is part of another known term (step 208). If not, the known term is indicated as such (step 210) and the system determines whether the process is now complete (step 206). If the known term is part of another term (step 208), then one of several determinations may be made depending on the options selected by the user and the embodiment of the present invention being employed. An exemplary second match processing method (step 212) is described below in FIG. 8. After returning from the second match processing (step 212), the system determines whether the process is now complete (step 206).

Referring to FIG. 8, first the system determines whether an active set is selected or a single glossary is being used (step 214). If there is an active set (step 214), the system determines whether the priority of the found second match is higher or lower than the existing match that it is a part of (step 216). If the priority of the second match is lower than that of the existing match (step 216), then the system checks whether all longest matches are to be returned (step 218). As discussed above, whether all longest matches or only the single longest match is returned is a user-selectable option.

If all longest matches are to be returned (step 218), then the second match is returned as a secondary found term (step 220) and the process returns (step 212). On the other hand, if only the single longest match is to be returned (step 218), then the system compares the second match to the existing match to determine whether the second match is the longest match (step 222). If not, the process returns (step 212). If so, the second match is indicated as the longest match and the existing match is no longer indicated (step 224). Then, the process returns (step 212).

If the priority of the second match is higher than the existing match (step 216), then the system still determines whether all longest matches are to be returned (step 226). If so, the second match is indicated as a primary match and the existing match is indicated as a secondary match to reflect priority (step 228). Then, the process returns (step 212). Otherwise, the system determines whether the second match is longer than the existing match (step 230). If so, the second match is indicated as the longest match and the existing match is no longer indicated (step 224) as above. However, if the second match is not the longest match (step 230), both the second match and the existing match are returned because the existing match is the longest match and the second match is a higher priority match (step 228). Then, the process returns (step 212).

Those skilled in the art will appreciate that the number of steps described above may be greater or fewer in number, or the steps may occur in a different sequence than shown above given the particular embodiment of the present invention being employed without departing from the scope of the invention.

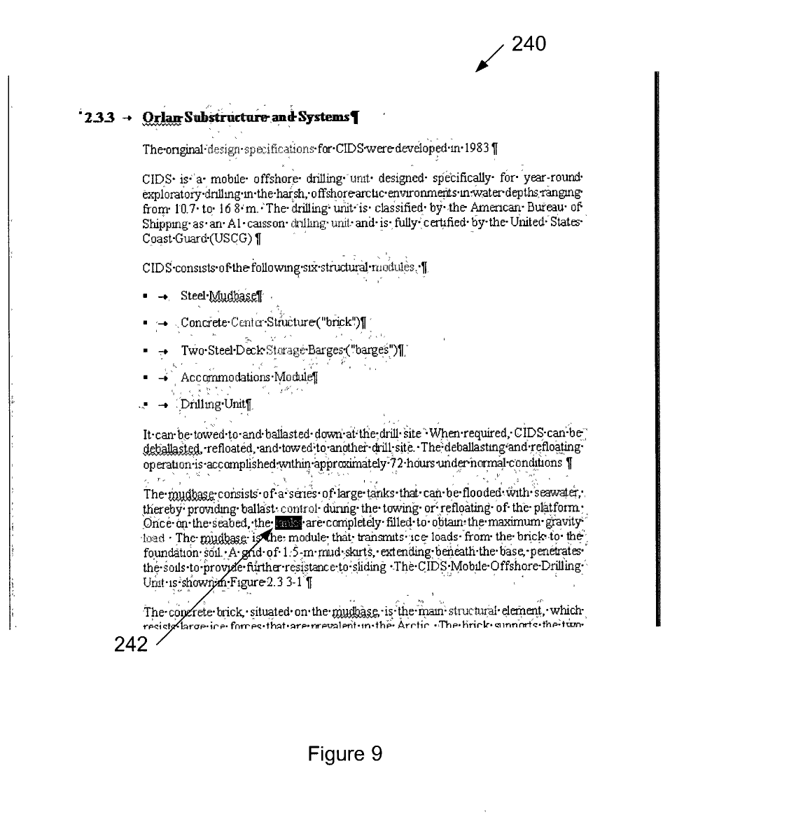

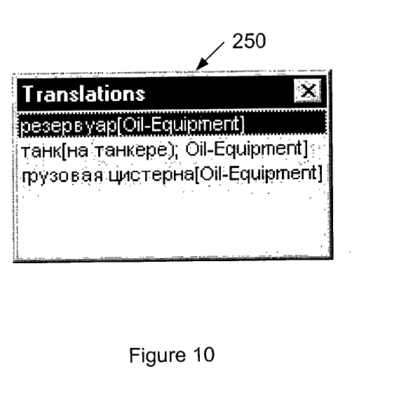

Referring to FIGS. 9-10, an exemplary document resulting from the comparison described above is shown. The document (240) is entirely the same text as the original document, however, as can be seen, indications exist throughout to show which terms are known terms. Further, different colors are used to show primary and secondary known terms. From these indications, expert translators will be able to quickly ascertain which terms are specific technical terms and which terms are common (at least to the selected glossary). After looking at the document having indications of known terms, a user can highlight a word or phrase indicated as known, e.g., the word “tanks” (252), and use the lookup button (48) or icon button (54) to see the matching translation (250).

In one or more embodiments, the present invention relates to a method and apparatus for foreign language translation involving Universe translation tools. The Universe translation tools include a glossary builder and a universal reference tool. The universal reference tool maintains a paired bilingual set of translated segments in a domain and a means to search through one or more domains. The glossary builder provides a means to modify a glossary by adding a paired bilingual set from a domain to the glossary.

Using the universal reference tool, a selected text string from an open document that is being translated is used to search through a domain. The domain contains a paired bilingual set of translated segments. For the purposes of this disclosure, a segment may include a word, words, a number, numbers, a sentence, a group of sentences, a paragraph and/or a group of paragraphs. The paired bilingual set may include a paired set of segments, each segment in a different language. As a result of a search of the domain, the segment that contains the selected text string and a translation of the segment may be displayed. Displaying the selected text string from the open document with its associated paired bilingual set of translated segments may be involved.

Furthermore, the Universe translation tools include a glossary builder to form and/or update one or more glossaries. The glossaries contain paired bilingual sets of translated segments that are specific to given identifiable topics. Glossaries aid a translator by providing direct translations for a selected text string. By using the glossary builder, a paired bilingual set may be added to a specific glossary.

Glossaries are project and/or subject specific documents and are more narrowly tailored to one or more translations of a given word or phrase than a dictionary. In contrast, dictionaries are typically broad documents covering all possible definitions and respective translations for a word or phrase. Further, the Universe translation tools apply to any language pair, e.g., English to/from French, English to/from Spanish, English to/from Russian, etc.

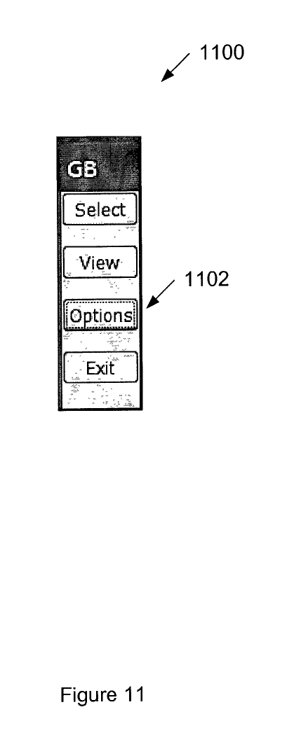

FIG. 11 shows an exemplary GUI visual output (1100) for a glossary builder in accordance with one or more embodiments of the present invention. The GUI visual output (1100) may be a floating toolbar. In the GUI visual output (1100), the “Options” button (1102) causes a glossary builder options window to be displayed. The glossary builder allows a user to modify a glossary to fit his or her specific translation needs.

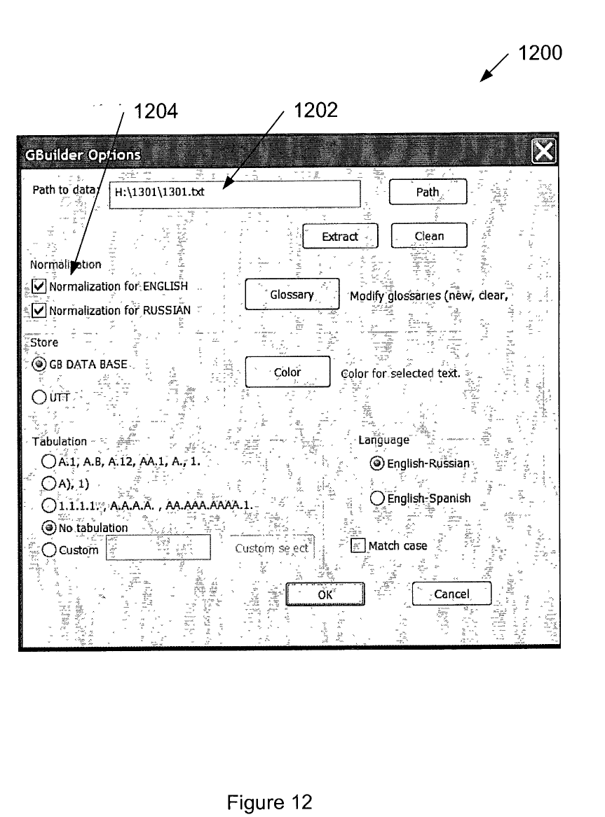

FIG. 12 shows an exemplary glossary builder options window (1200) in accordance with one or more embodiments of the present invention. The glossary builder options window (1200) allows one or more glossaries to be modified or created. Access to a particular glossary is input by the user, or selected by the Universe translation tools, using “Path to data” (1202) box. The glossary builder options window (1200) allows the particular glossary to be normalized dependent on a selected language using a “Normalization” (1204) option. For example, either English or Russian or both may be normalized.

Normalization is a process which is used to bring words to their root component. A normalized word may aid in a comparison step. Normalized words may also be stored in a glossary. For the English language, normalization involves finding plural nouns and past tense verbs and converting them to singular and present tense respectively. Those skilled in the art will appreciate that in other languages normalization may involve a more complex determination of the root component of a particular word.

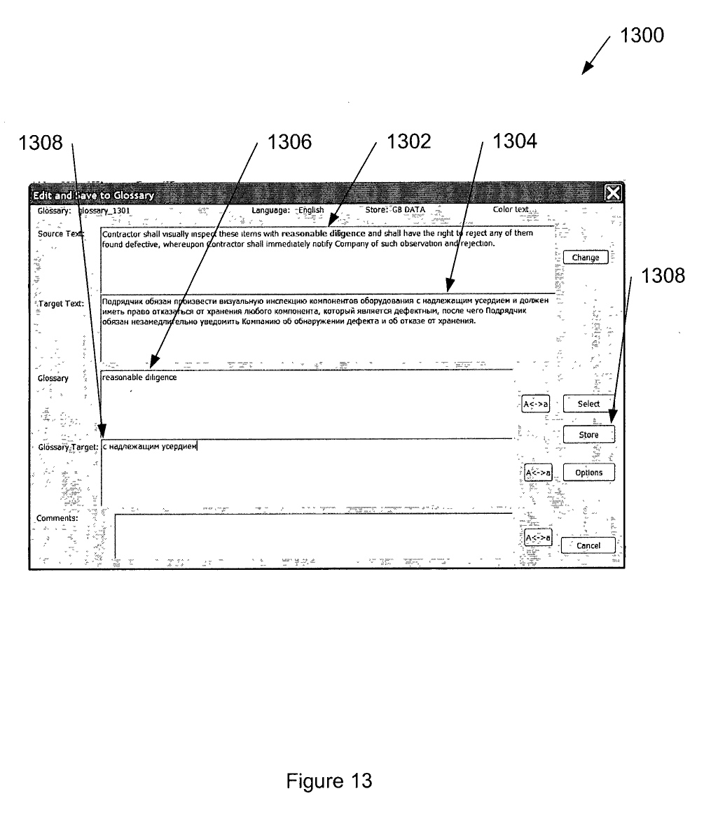

FIG. 13 shows an exemplary glossary builder window (1300) in accordance with one or more embodiments of the present invention. A “Source Text” box (1302) shows a highlighted, selected text string of interest, or “text string,” in a segment from which it was found. A “Target Text” box (1304) displays a translation of the segment shown in the “Source Text” box (1302) which is taken from a particular domain loaded into the software. The text string is shown in a “Glossary” box (1306), and a translation of the text string is shown in a “Glossary Target” box (1308).

A human translator may decide that the text string and/or the translation of the text string may not have a desired corresponding translation. Accordingly, the text string in the “Glossary” box (1306) and/or the translation of the text string in the “Glossary Target” box (1308) may be modified. Assuming that the text string in the “Glossary” box (1306) and the translation of the text string in the “Glossary Target” box (1308) are as desired, the “Store” (1308) button can be used to save to a glossary both the text string and the translation of the text string as a paired bilingual set. The text string and the translation of the text string stored as a paired bilingual set in a glossary are each referred to as “terms.”

The glossary in which the text string and translation of the text string are saved is indicated in the upper, left corner of the glossary builder window (1300) as selected from the glossary builder options window (1200) shown in FIG. 12. A translation of an open document compares a parsed text string from the open document to terms in one or more glossaries. The glossary may be arranged to contain terms consistent with a particular field or document type. The glossary may contain technical, or otherwise specifically-definable, terms such that the remaining, untranslated words in a document are readily translated by the user.

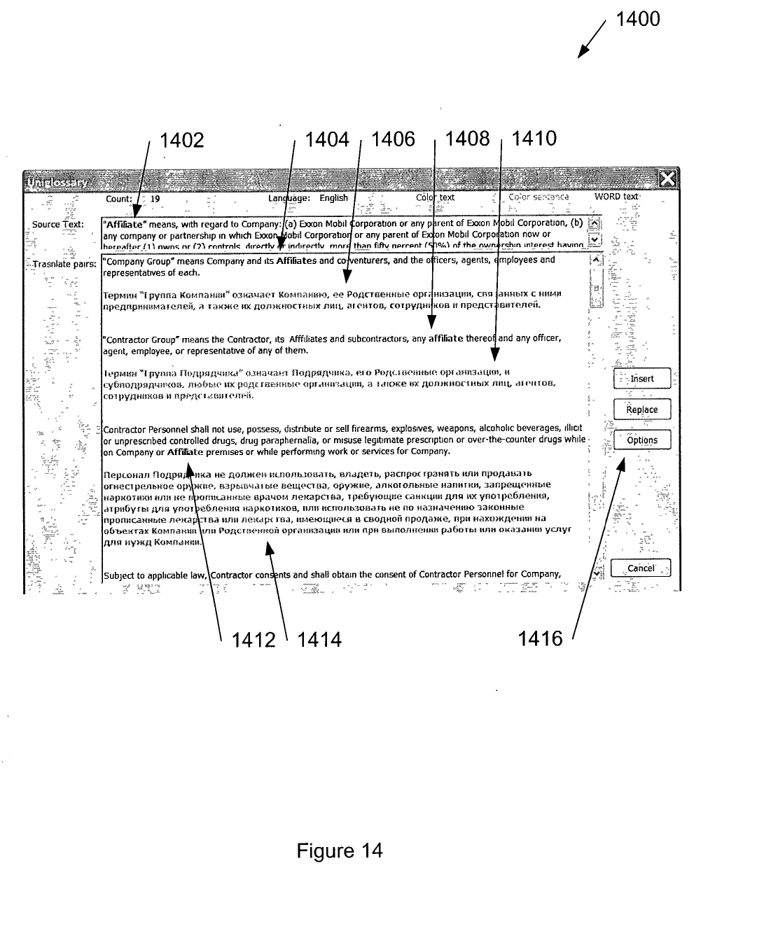

FIG. 14 shows an exemplary domain search result window (1400) in accordance with one or more embodiments of the present invention. The domain search result window (1400) may be the result of a search using a universal reference tool. The domain search result window (1400) displays not only a selected text string from an open document to be translated, but also a segment for the selected text string. For example, a word “Affiliate” is a selected text string in a “Source Text” (1402) box. The selected text string is displayed with its segment in the “Source Text” (1402) box.

A search of a domain for segments that contains the selected text string is completed. Matches between the selected text string and the selected text string in one or more of the segment within the domain are reported. The selected text string may be normalized to improve the ability to match the selected text string with the segment in the domain. Also, the segment in the domain may be normalized to improve the ability to match the selected text string. In either case, the search is performed on the domain in the same language as the selected text string. Upon finding occurrences, or optionally “near” occurrences, of a match, the segment for the occurrence together with the translation of the segment is displayed.

One of ordinary skill in the art will understand that a segment and a translation of the segment may be displayed that may be the result of a complete or partial match. The partial match may have been determined by how “near” the selected text string is to a segment in the domain. One of ordinary skill in the art will understand that a domain search may be refined using logical operators, e.g., “AND,” “OR,” and “NOT.”

The domain search result window (1400) displays the segment containing the matching text string and a paired translation of the segment from the domain. For example, the word “Affiliate” is the selected text string. “Affiliate” is the normalized term that is used in the search of the domain. In this example, “Affiliate” is located in 19 different occurrences (as indicated in the upper, left corner of the domain search result window (1400)). Each occurrence is displayed with the segment (1404, 1408, 1412) and a translation of the segment (1406, 1410, 1414). A text in the segment (1404, 1408, 1412) that was matched to the selected text string is highlighted.

“Affiliate” may be a noun, a verb, and/or plural. “Affiliated” is an adjective. The segment helps the user determine the proper translation. In the domain search result window (1400), the user may select the desired translation and replace the selected text string in the open document that is being translated with the selected translation.

Domains may be project and/or subject specific and may be more narrowly tailored to one or more translations of a given word or phrase. Domains may be turned “off” or “on” such that the domains are added or removed from the active set of domains, respectively. Domains in the active set of domains may be prioritized such that the terms in one domain are searched and reported prior to matches in other domains.

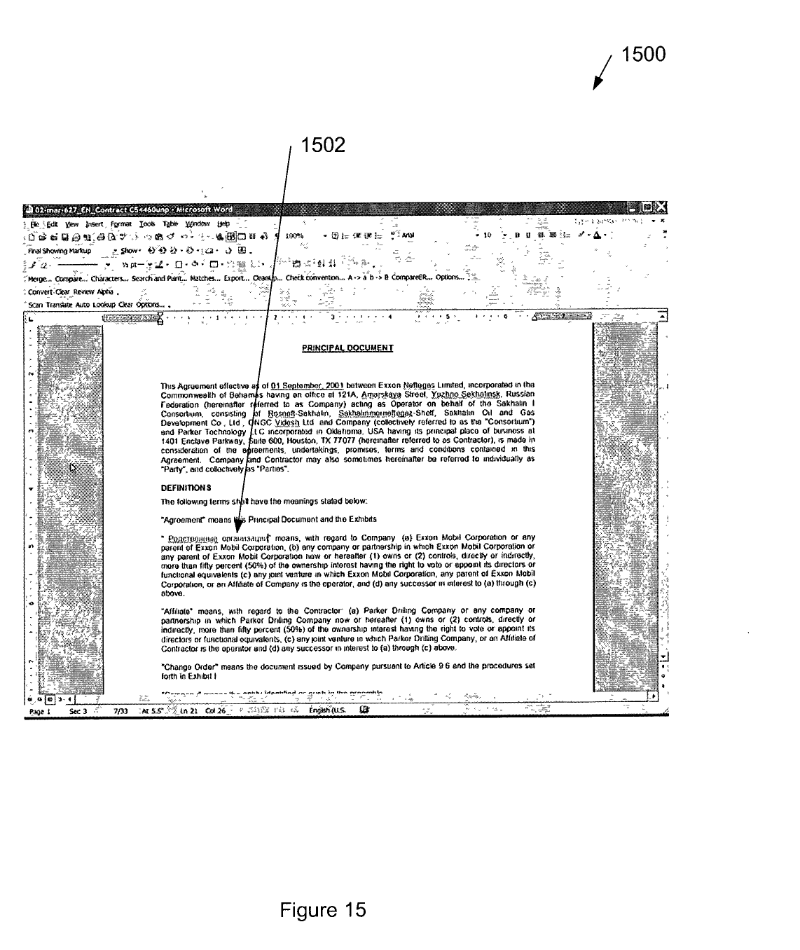

FIG. 15 shows an exemplary document (1500) after replacement in accordance with one or more embodiments of the present invention. The document (1500) shows an open document in the middle of being translated. The document (1500) had “Affiliate” as the selected text string. A translation search of a normalized version of “Affiliate” resulted in the domain search result window (1400) shown in FIG. 14. The user selected a desired translation based not only on the direct translation of the selected text string, but also on an unnormalized or normalized segment in which the unnormalized or normalized selected text string existed. The user selected the desired translation and replaced the selected text string with the selected translation (1502) in the document (1500). The translation may also be modified by the user before replacement.

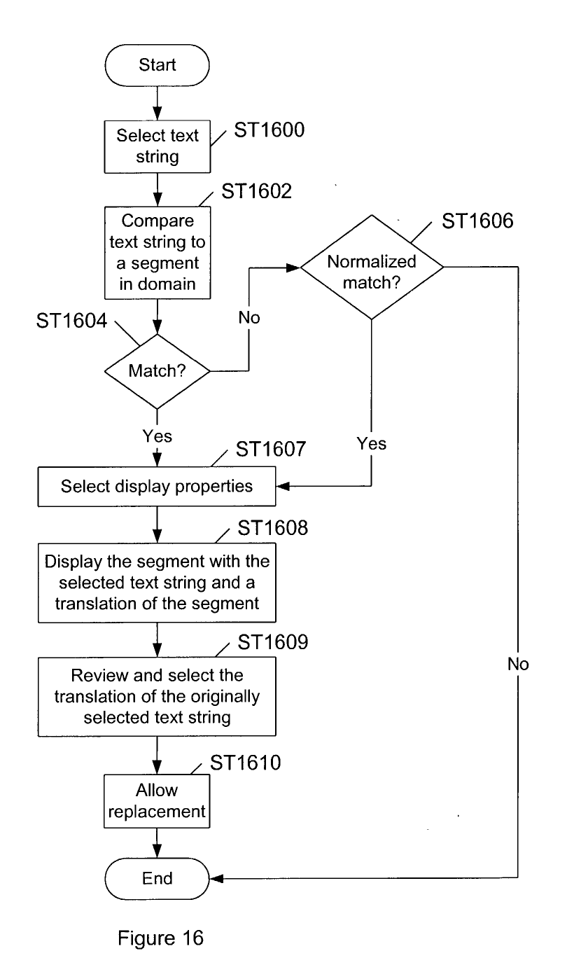

FIG. 16 is a flow diagram describing a process in accordance with one or more embodiments of the present invention. A user may desire to translate a text string; however, the selected text string may have different translations dependent on a context in which the selected text string is used. A display of possible translations in context may be useful. For example, previously translated paired bilingual sets that contains a translation for the selected text string may be displayed. FIG. 14, as described above, shows one embodiment.

When a user selects a text string and an appropriate translation invoking button as described above (step 1600), the selected text string in an open document is compared against a segment in a domain (step 1602). The domain includes a paired bilingual set. The selected text string is compared to the segment in the same language as the selected text string. If one or more occurrences of a match are identified (step 1604), the user may select display properties (step 1607).

A match may return one or more paired bilingual sets. The display properties (step 1607) allow the user to provide preferences as to how the one or more occurrences of the paired bilingual sets are displayed. A statistical analysis of the translated segments in the paired bilingual sets may be performed so that the translated segments can be analyzed for a common element. If there is a common element, the common element will be displayed as a suggested translation. If there is more than one common element then several suggested translations may be displayed. If there is no common element then the translated segments may be grouped according to commonalities of the common elements.

The statistical analysis may be based on a direct match or, for example, a match that provides the “most” similarity. Similarity may be based on the number of words that match, a distance measure, or other statistical analysis methods to determine commonality between segments.

A domain search result window displays a segment with the selected text string and the one or more occurrences of a matching segment paired with a translation of the segment (step 1608) resulting from step 1604. The display (step 1608) may be dependent on the display properties (step 1607) selected by the user. The user may review, select, and/or edit the desired translation of the originally selected text string (step 1609). The desired translation may replace the originally selected text string in the open document (step 1610).

If an occurrences of a match is not identified (step 1604), the selected text string and/or one or more domains may be normalized to aid in the identifying an occurrence. If a normalized match (step 1606) occurs, the user may select display properties (step 1607), display the segment with the selected text string and a translation of the segment (step 1608), review and select the translation of the originally selected text string (step 1609), and allow translation (step 1610) as described above.

One of ordinary skill in the art will understand that it may be sufficient to show only a translated segment or only a segment paired with a translation of the segment. One of ordinary skill in the art will understand that it may be sufficient to show only a selected text string with a translated segment or the selected text string in a segment with a translated segment. One of ordinary skill in the art will understand that a matching text string or a selected text string may or may not be highlighted or colored. One of ordinary skill in the art will understand that a paired bilingual set may be added, removed, or modified in one or more domains.

One of ordinary skill in the art will understand that selecting display properties (step 1607) may occur before or during a search. The display properties (step 1607) may be modified dependent on the needs of a user.

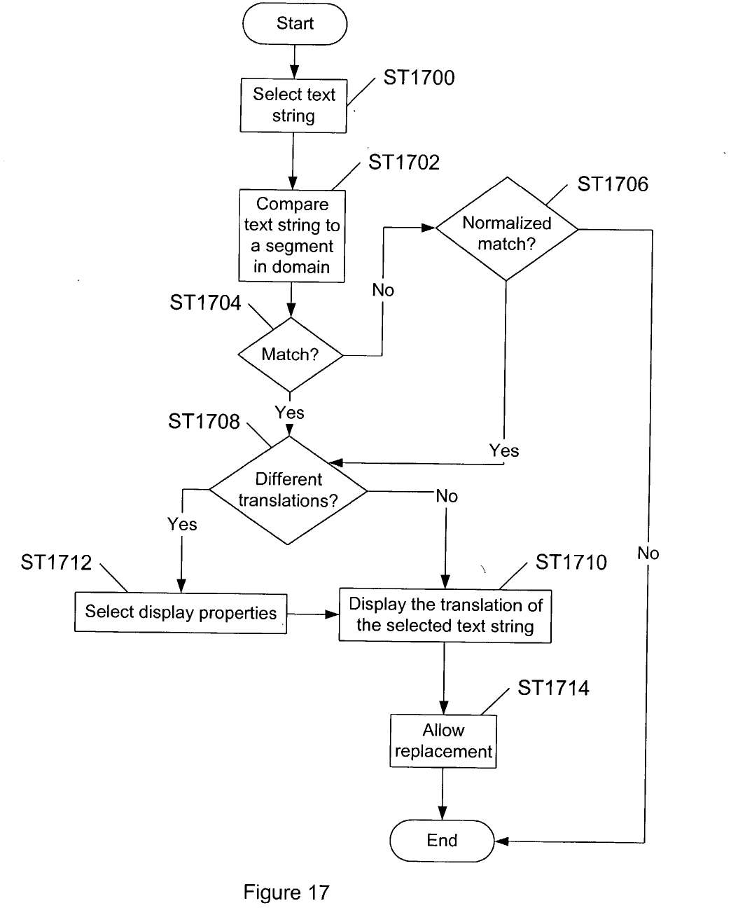

FIG. 17 is a flow diagram describing a process in accordance with one or more embodiments of the present invention. A user may desire to translate a text string; however, one or more translations may exist. A display of one or more possible translations may be useful. In one embodiment of the present invention, potential match(es) may be compared to a selected text string to determine which potential matches are most similar. Furthermore, potential match(es) may be compared to each other for similarity. A display of the potential match(es) may be ordered or grouped dependent on the similarities.

When a user selects a text string and an appropriate translation invoking button as described above (step 1700), the selected text string in an open document is compared against a segment in a domain (step 1702). The domain includes a paired bilingual set. The selected text string is compared to the segment in the same language as the selected text string.

If one or more occurrences of a match are identified (step 1704), a record of a translation of the segment with the selected text string is maintained. If an occurrence of a match is not identified (step 1704), the selected text string and/or one or more domains may be normalized to aid in the identifying an occurrence. If one or more occurrences of a match are identified after normalization (step 1706), a record of a translation of the segment with the text string is maintained. After completion of the matching step(s) (steps 1704, 1706), if one or more occurrences of a match are identified, a comparison of the resulting translation(s) is completed.

If only one translation occurs (step 1708), a domain search result window displays the translation of the selected text string (step 1710). If more than one translation occurs (step 1708), a user may select which of the multiple translations are displayed (step 1712). A text string to be translated may return many valid translations. In one embodiment of the present invention, the translations may be displayed based on the number of times a particular translation occurs. The most common translation may be displayed; a limited number of translations may be display; or all translations may be displayed.

Furthermore, a statistical analysis of the translated segments may be performed so that the translated segments can be analyzed for a common element. If there is a common element, the common element will be displayed as a suggested translation. If there is more than one common element then several suggested translations may be displayed. If there is no common element then the translated segments may be grouped according to commonalities of the common elements.

The statistical analysis may be based on a direct match or, for example, a match that provides the “most” similarity. Similarity may be based on the number of words that match, a distance measure, or other statistical analysis methods to determine commonality between segments.

After displaying the selected text string and the translation of the selected text (step 1710), the user may select or edit the matching occurrence to replace the selected text string in the open document (step 1714).

One of ordinary skill in the art will understand that it may be sufficient to show only the translation(s) of the selected text string. One of ordinary skill in the art will understand that a paired bilingual set may be added, removed, or modified in one or more domains. One of ordinary skill in the art will understand that selecting display properties (step 1712) may occur before or during a search. The display properties (step 1712) may be modified dependent on the needs of a user.

Advantages of one or more embodiments of the present invention may include one or more of the following. In one or more embodiments, the present invention facilitates the translation of a text string that may include words, numbers, sentences, and phrases by noting terms appearing in a document that correspond to technical or otherwise significant words, numbers, sentences, and phrases stored in glossaries. Which glossaries to be searched and the priority of matches found can be specified. By having selectable glossaries of terms, translations performed by different expert translators will be uniform. Technical terms that having a given meaning in the technical segment and a separate meaning in regular usage will be properly translated. Easily translatable terms can be suggested or completely left to expert translators.

In one or more embodiments, the present invention facilitates the translation of a selected text string that may include words, sentences, and phrases by matching words, sentences, and phrases stored in a domain. Which domain to be searched and the priority of matches found can be specified. By having selectable domains, translations performed by different expert translators will be uniform. Technical text strings that have a given meaning in a technical segment and a separate meaning in regular usage will be properly translated. Easily translatable terms can be suggested or completely left to expert translators.

In one or more embodiments of the present invention, automatic translation of the most difficult project-specific terminology can be performed. Automatic and full utilization of a domain database during the translation process is possible. Absolute compliance with project approved terminology and full compliance of the translated materials with the approved domain can be efficiently effected. Faster, more consistent and accurate translation can be obtained. Domains of preprocessed material for distribution to freelancer translators are provided. Ease of updates and traceability, and ease of domain database management is increased.

In one or more embodiments of the present invention, glossaries of terms may be created, modified, turned off or on, and prioritized as necessary. The terms within the glossaries may added directly by a user or added by the user from search results. Matches between text strings and terms within one or more glossaries may be displayed in a segment to aid the user. An appropriate term or an edited version of a displayed term may replace all or a portion of the selected text string. Those skilled in the art appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A translation management method comprising:
comparing a selected text string to a segment in a first domain;
indicating a match between the selected text string and at least a portion of the segment;
displaying the selected text string and a matching segment paired with a translation of the matching segment; and
selectively allowing replacement of the selected text string with at least a portion of the translation of the matching segment.

2. The translation management method of claim 1, further comprising:
comparing the selected text string to a segment in a second domain.

3. The translation management method of claim 2, further comprising:
normalizing the selected text string before comparing the selected text string for a match with a segment in at least one selected from the group consisting of the first domain and the second domain.

4. The translation management method of claim 2, wherein at least one of the first domain and the second domain may be selectively turned off.

5. The translation management method of claim 2, wherein the comparing prioritizes use of the first domain and the second domain.

6. The translation management method of claim 2, further comprising:
including a new segment paired with a translation of the new segment to at least one selected from the group consisting of the first domain and the second domain.

7. The translation management method of claim 6, wherein the new segment is normalized.

8. The translation management method of claim 6, wherein the translation of the new segment is normalized.

9. A translation management tool, comprising:
a first domain containing a segment and a translation of the segment; and
software executable on a computer for
comparing a selected text string to the segment;
indicating a match between the selected text string and at least a portion of the segment;
displaying the selected text string and a matching segment paired with a translation of the matching segment; and
selectively allowing replacement of the selected text string with at least a portion of the translation of the matching segment.

10. The translation management tool of claim 9, wherein the software is further for comparing the selected text string to a segment in a second domain.

11. The translation management tool of claim 10, wherein the software is further for normalizing the selected text string before comparing the selected text string for a match with a segment in at least one selected from the group consisting of the first domain and the second domain.

12. The translation management tool of claim 10, wherein at least one of the first domain and the second domain may be selectively turned off.

13. The translation management tool of claim 10, wherein the comparing prioritizes use of the first domain and the second domain.

14. The translation management tool of claim 10, wherein the software is further for including a new segment paired with a translation of the new segment to at least one selected from the group consisting of the first domain and the second domain.

15. The translation management tool of claim 14, wherein the new segment is normalized.

16. The translation management tool of claim 14, wherein the translation of the new segment is normalized.

17. A translation management tool comprising:
at least one domain containing a segment paired with a translation of the segment;
means for comparing a selected text string to the segment in the at least one domain;
means for indicating matches between the selected text string and at least a portion of the segment;
means for displaying the selected text string and a matching segment paired with a translation of the matching segment; and
means for selectively allowing replacement of the selected text string with at least a portion of the translation of the matching segment.

18. A translation management method comprising:
displaying a segment in a first language;
displaying a translation of the segment in a second language;
indicating a term from the segment;
indicating a translation of the term from the translation of the segment; and
adding the term and the translation of the term as a paired bilingual set to a specified glossary.

19. The translation management method of claim 18, further comprising:
allowing the term and the translation of the term to be modified before the adding.

20. A translation management tool, comprising:
a first glossary containing a first term and a translation of the first term;
a second glossary containing a second term and a translation of the second term; and
software executable on a computer for
displaying a segment in a first language;
displaying a translation of the segment in a second language;
indicating a term from the segment;
indicating a translation of the term from the translation of the segment; and
adding the term and the translation of the term as a paired bilingual set to at least one of the group consisting of the first glossary and the second glossary.

21. A translation management method comprising:
comparing a selected text string to a plurality of paired bilingual segments in a domain;
determining a match between the selected text string and at least a portion of a first paired bilingual segment in the plurality of paired bilingual segments;
determining a match between the selected text string and at least a portion of a second paired bilingual segment in the plurality of paired bilingual segments;
statistically analyzing a commonality between the first paired bilingual segment and the second paired bilingual segment in at least one language;
displaying a translation of the selected text string dependent on the statistically analyzing; and
selectively allowing replacement of the selected text string.
